(19) United States
(12) Patent Application Publication
(10) Pub. No.: US 2017/0023826 A1
(43) Pub. Date: Jan. 26, 2017

(54) DISPLAY APPARATUS HAVING MIRROR FUNCTION AND METHOD FOR PRODUCING THE SAME

(71) Applicant: BOE Technology Group Co., Ltd., Beijing (CN)

(72) Inventor: Miki Kashima, Beijing (CN)

(21) Appl. No.: 15/124,429

(22) PCT Filed: May 12, 2015
(86) PCT No.: PCT/CN2015/078794

§ 371 Date: Sep. 8, 2016

(30) Foreign Application Priority Data
Jan. 22, 2015 (CN) 201510032984.6

(51) Int. Cl. G02F 1/1335; G02F 1/13363; G02F 1/137

(52) U.S. Cl. CPC G02F 1/133555; G02F 1/13718; G02F 1/13363; G02F 1/133528; G02F 2001/133638

(57) ABSTRACT

Embodiments of the present disclosure provide a display apparatus having a mirror function. The display apparatus includes a display panel and a mirror panel. The mirror panel is provided at a light exiting side of the display panel, wherein the mirror panel is configured to permit a part of polarized light from the display panel to transmit therethrough while reflecting a part of ambient light. In addition, another embodiment of the present disclosure also provides a method for producing a display apparatus having a mirror function.

### CROSS-REFERENCE TO RELATED APPLICATION

This application claims the benefit of Chinese Patent Application No. 201510032984.6 filed on Jan. 22, 2015 entitled with “DISPLAY APPARATUS HAVING MIRROR FUNCTION AND METHOD FOR PRODUCING THE SAME” in the State Intellectual Property Office of China, the disclosure of which is incorporated herein by reference.

### BACKGROUND OF THE INVENTION

Field of the Invention

The present disclosure relates to the technical field of liquid crystal display, and particularly, to a display apparatus having a mirror function and a method for producing the same.

Description of the Related Art

A display panel of a liquid crystal display can have a mirror function. However, the existing display panel can only achieve switch among the mirror function, a display function and a fully perspective function.

There is a need in the market for such display apparatus that can realize both the display function and the mirror function at a same time point.

### SUMMARY

The present disclosure aims to at least provide a display apparatus and a method for producing the same, which allows a user to clearly see display contents therein while being used a mirror.

In accordance with an aspect of the present disclosure, it provides a display apparatus having a mirror function, comprising:

a display panel;

a mirror panel, provided at a light exiting side of the display panel, wherein the mirror panel is configured to permit a part of polarized light from the display panel to transmit therethrough while reflecting a part of ambient light.

In one example, the mirror panel comprises:

a first transparent substrate and a second transparent substrate arranged opposite to each other;

transparent electrode layers arranged respectively on opposite inner side surfaces of the first and second transparent substrates; and

a cholesteric liquid crystal layer provided between the respective transparent electrode layers of the first and second transparent substrates.

In one example, the display panel is a liquid crystal display panel, and the second transparent substrate is provided on the liquid crystal display panel.

In one example, the display apparatus further comprises:

a ¼ wavelength sheet provided between the display panel and the mirror panel.

In one example, the display apparatus further comprises a power supply system comprising a power source and a power source control part, wherein the power source is electrically connected to the transparent electrode layers of the first transparent substrate and the second transparent substrate respectively.

In one example, the power source control part is adapted to control the power source to output a low frequency alternating voltage, and based on the applied low frequency alternating voltage, the cholesteric liquid crystal layer permits transmission of a part of the polarized light from the display panel while reflecting a part of the ambient light.

In one example, the power source control part is adapted to control the power source to output a high frequency alternating voltage, and based on the applied high frequency alternating voltage, the cholesteric liquid crystal layer presents a pitch gradient distribution so as to prevent transmission of the light from the display panel while reflecting the ambient light.

In one example, the power source control part is adapted to cut off the power source, thereby keeping the cholesteric liquid crystal layer in a transparent state so as to permit the transmission of all of the polarized light from the display panel.

In one example, the mirror panel comprises:

a first transparent substrate and a second transparent substrate arranged opposite to each other; and

a wide wave reflection macromolecule liquid crystal layer provided between inner side surfaces of the first and second transparent substrates,

wherein the wide wave reflection macromolecule liquid crystal layer permits the transmission of the circularly polarized light from the display panel while reflecting a part of the ambient light.

In one example, the display panel is a liquid crystal display panel and comprises a polarizer located at the light exiting side thereof;

the display apparatus further comprises a ¼ wavelength sheet provided between the polarizer of the display panel and the second transparent substrate of the mirror panel, and an angle between a transmission axis of the polarizer and an optical axis of the ¼ wavelength sheet is +45°.

In one example, the wide wave reflection macromolecule liquid crystal layer is in a form of a film in which a twisted crystalline phase and a cholesteric phase are coexisted.

In accordance with another aspect of the present disclosure, it provides a method for producing a display apparatus having a mirror function, comprising the steps of:

providing a display panel;

providing a mirror panel; and

disposing the mirror panel at a light exiting side of the display panel, wherein the mirror panel permits a part of polarized light from the display panel to transmit therethrough while reflecting a part of ambient light.

In one example, the step of providing the mirror panel comprises:

providing a first transparent substrate and a second transparent substrate arranged opposite to each other, and providing transparent electrode layers at opposite inner side surfaces of the first and second transparent substrates;

applying negative liquid crystals between respective transparent electrode layers of the first and second transparent substrates, a chiral ionic liquid being added into the negative liquid crystals.

In one example, the method further comprises the step of:

providing a power supply system having a power source and a power source control part, wherein the power source is electrically connected to the two transparent electrode layers of the first and second transparent substrates respectively; and

controlling the power source by the power source control part:

(1) to output a low frequency alternating voltage, so that based on the applied low frequency alternating voltage the mirror panel is configured to permit a part of polarized light from the display panel to transmit therethrough while reflecting a part of the ambient light;

(2) to output a high frequency alternating voltage, so that based on the applied high frequency alternating voltage the cholesteric liquid crystal layer presents a pitch gradient distribution, so as to prevent passage of the light rays from the display panel and to only reflect the ambient light;

(3) to cut off supply of electricity power to the mirror panel, so that the cholesteric liquid crystal layer maintains a transparent state so as to permit all of the polarized light from the display panel to transmit therethrough.

In one example, the step of providing a mirror panel comprises:

providing a first transparent substrate and a second transparent substrate arranged opposite to each other;

providing a wide wave reflection macromolecule liquid crystal layer between inner side surfaces of the first and second transparent substrates, wherein the wide wave reflection macromolecule liquid crystal layer has a characteristic of the cholesteric liquid crystal layer.

In one example, the method further comprises:

providing a ¼ wavelength sheet between the light existing side of the display panel and the mirror panel.

In one example, the step of providing the wide wave reflection macromolecule liquid crystal layer comprises:

adding a light initiator into a monomer having a photo polymerization group liquid crystal; and

illuminating the monomer with UV light in a range of a temperature higher than transition temperatures of the negative cholesteric phase and a near crystalline A phase of liquid crystal by 10 degrees, so as to obtain the wide wave reflection macromolecule liquid crystal layer.

With the technical solutions of the respective examples of the present disclosure, the display apparatus can provide both the display function (i.e., display contents of the display panel can be seen based on the part of polarized light which is transmitted through the display panel) and the mirror function (i.e., for example the user can see a reflection image of his/her own based on the reflected part of the ambient light) at the same time point.

### BRIEF DESCRIPTION OF THE DRAWINGS

FIG. 1 is a schematic cross-sectional view for showing a structure of a display apparatus having a mirror function in accordance with a first embodiment of the present disclosure;

FIG. 2 is a schematic cross-sectional view for showing a structure of a display apparatus having a mirror function in accordance with a second embodiment of the present disclosure;

FIG. 3 is a schematic view of a liquid crystal texture of a negative liquid crystal added with a chiral ionic liquid without any voltage being applied, and being in a transmission state; and

FIG. 4 is a schematic view of a liquid crystal texture of the negative liquid crystal added with a chiral ionic liquid with a high frequency alternative current power supply being provided, and being in a mirror reflection state.

### DETAINED DESCRIPTION OF PREFERRED EMBODIMENTS OF THE INVENTION

Below, in conjunction with the accompanying drawings, a display apparatus having a mirror function and a method for producing the same provided by embodiments of the present disclosure are explained in detail.

Sizes and shapes of respective components in the drawings do not reflect a real scale of a display apparatus having the mirror function, and are only intended to illustrate the contents of the present disclosure.

Cholesteric liquid crystal is identical with other kinds of liquid crystals, since it not only has a flowability, a deformability and a viscosity of liquid, but also has anisotropy of crystals to light, being a good non-linear optical material. As the cholesteric liquid crystal has a particular molecule structure and optical anisotropy, it has properties such as optical activity of the crystals, dichromatism of polarized light and its inherent selective light scattering property. A pitch of the cholesteric liquid crystal is very important for its optical property. Characteristics of light transmission and selective light scattering mainly depend on its pitch. For example, as for a right hand cholesteric liquid crystal having a pitch close to a wavelength of an incident light, if a left hand light is incident, it will generate light transmission; if a right hand light is incident, it will generate a light scattering identical with Bragg reflection.

The display apparatus having the mirror function and the corresponding producing method thereof according to the present disclosure are provided based on the characteristics of the cholesteric liquid crystal.

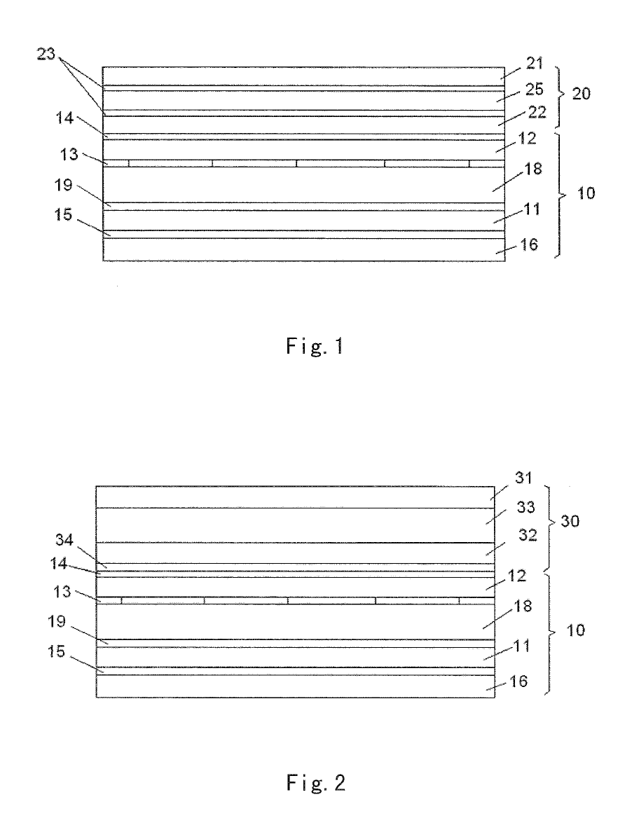

As shown in FIGS. 1-2, the present disclosure provides a display apparatus having a mirror function, including:

a liquid crystal display panel 10;

a mirror panel 20/30, configured to have characteristics of cholesteric liquid crystal and located at a light exiting side of the liquid crystal display panel 10.

The mirror panel 20/30 permits to transmit a part of polarized light from the display panel 10 while reflecting a part of ambient light.

It should be noted that the display panel of the present disclosure is not limited to the liquid crystal display panel.

With a technical solution of the present disclosure, the mirror panel can permit to transmit only a part of polarized light from the display panel 10 while reflecting a part of ambient light. As such, the display apparatus can have both the display function (i.e., display contents of the display panel can be seen based on the transmitted part of the polarized light) and the mirror function (i.e., for example the user can see a reflection image of his/her own based on the reflected part of the ambient light) at the same time point.

Below, the display apparatus having the mirror function in accordance with one embodiment of the present disclosure is described with reference to FIG. 1.

As shown in FIG. 1, the liquid crystal display panel 10 for example includes: a lower side (transparent) substrate 11, thin film transistors (TFTs) being formed in a transparent pixel electrode layer 19 on the lower side substrate 11; an upper side substrate 12 arranged opposite to the lower side substrate 11 and having a transparent common electrode layer (not shown); a color filter 13 provided at a lower side of the upper side substrate 12; a liquid crystal layer provided between the pixel electrode layer of the lower side substrate 11 and the common electrode layer of the upper side substrate 12; an upper polarizer 14 provided at an upper side of the upper side substrate 12; and a lower polarizer 15 and a backlight source 16 provided at a lower side of the lower side substrate 11. It can be understood that the liquid crystal display panel 10 as shown in FIG. 1 is only one illustrative example, and for example it can also include components, such as color filters and black matrix, that are commonly provided for constituting a liquid crystal display panel. Since the liquid crystal display panel is well known, the present invention will not discuss it in detail.

As shown in FIG. 1, the mirror panel 20 includes:

a first transparent substrate 21 and a second transparent substrate 22 arranged opposite to each other;

transparent electrode layers 23 arranged respectively on opposite inner side surfaces of the first and second transparent substrates 21 and 22;

a cholesteric liquid crystal layer 25 provided between the transparent electrode layers of the first and second transparent substrates 21 and 22. Specifically, this cholesteric liquid crystal layer is consisted of negative liquid crystals 252 and a chiral ionic liquid 251 added within the negative liquid crystals 252.

The display apparatus further includes a power supply system for providing electric power to the mirror panel 20. The power supply system includes a power source 24 (see FIG. 4) and a power source control part (not shown). The power source is electrically connected to two transparent electrode layers 23 of the first transparent substrate 21 and the second transparent substrate 22 respectively.

In particular, the power source control part is suitable or adapted to control the power source 24 to output a low frequency alternating voltage, and based on the applied low frequency alternating voltage, the mirror panel 10 permits transmission of a part of polarized light from the display panel while reflecting a part of the ambient light.

With such technical solution, the liquid crystal display panel 10 and the mirror panel 20 are controlled so that good effects of display and mirror can be achieved at the same time.

In an example of FIG. 1, a ¼ wavelength sheet may be provided at the light exiting side of the display panel. However, it is not necessary to provide a ¼ wavelength sheet at the light exiting side of the display panel in the present invention. In the case that the ¼ wavelength sheet is provided, the light from the display panel can be transmitted through the mirror panel more than that in the case that the ¼ wavelength sheet is not provided.

Any kind of the low frequency alternating voltages which can achieve the function that “the mirror panel 10 permits transmission of a part of polarized light from the display panel while reflecting a part of the ambient light”, can be used herein. For example, this low frequency alternating voltage can have a frequency in a range of 100-200 Hz.

The power source control part is also adapted to control the power source 24 to output a high frequency alternating voltage, for example higher than 8000 Hz, after the chiral ionic liquid is migrated to the substrate side of the mirror panel under the action of the direct current electric field. Based on the applied high frequency alternating voltage, the mirror panel 20 prevents transmitting of the light from the display panel 10 while reflecting the ambient light. FIG. 4 shows that the transparent electrode layer 23 of the mirror panel 20 is applied with the high frequency alternating voltage. In FIG. 4, the structure of the negative liquid crystals 252 is translated into a planar texture. Because the chiral ionic liquid is distributed and focused at one side where the electrode is located, and the negative liquid crystals 252 present a pitch gradient distribution, a mirror reflection state is presented. In this case, the mirror panel 20 only provides a mirror function, and the user does not see any content of the display panel 10 at all.

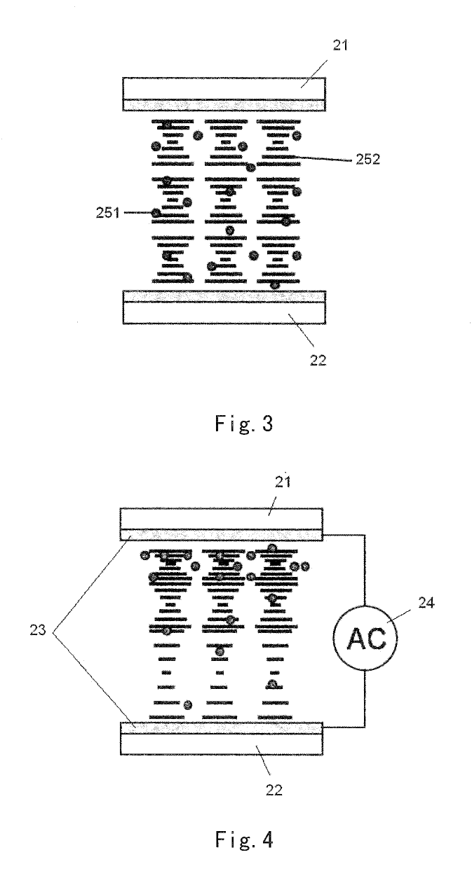

Preferably, the power source control part is also adapted to cut off the power source, thereby keeping the mirror panel 20 in a transparent state so as to permit the transmission of all of the polarized light from the display panel. FIG. 3 shows a state of the negative liquid crystals 252 after cutting off the power source, and at this time a full transmitting state is presented. In this case, the user can select to watch the contents of the display panel whereas the mirror panel 20 does not provide any mirror function.

It can be seen that utilizing the mirror panel 20 as shown in FIG. 1 of the present disclosure is not only capable of achieving the function that the mirror panel 10 permits the transmission of a part of the polarized light from the display panel while reflecting a part of the ambient light (i.e., achieving the display function and the mirror function at the same time), but also can achieve the fully perspective function that the display contents of the display panel can be observed and the fully mirror function that the mirror panel is only used as a mirror.

A display apparatus having a mirror function in accordance with another embodiment of the present disclosure is set forth with reference to FIG. 2 below. As shown in FIG. 2, the display panel 10 herein has the same structure as that of the display panel in FIG. 1. The mirror panel 30 includes a first transparent substrate 31 and a second transparent substrate 32 arranged opposite to each other, and a wide wave reflection macromolecule liquid crystal layer 33 provided between inner side surfaces of the first and second transparent substrates 31 and 32, which has the characteristic of the cholesteric liquid crystal layer, that is, the wide wave reflection macromolecule liquid crystal layer permits the transmission of the circularly polarized light from the display panel while reflecting a part of the ambient light.

As shown in FIG. 2, the display apparatus further includes a ¼ wavelength sheet 34 covered at the outside of the second transparent substrate 32, and configured to cover an upper polarizer 14. In the case that the display panel is not a liquid crystal display panel, it may be not necessary to provide the polarizer, and the ¼ wavelength sheet 34 can be directly provided at the light exiting side of the display panel. In this case, the ¼ wavelength sheet 34 can be considered as an integral part of the mirror panel 30. Of course, the ¼ wavelength sheet 34 can also be considered as one separate component.

The wide wave reflection macromolecule liquid crystal has a very wide reflection wavelength range and the characteristic of the cholesteric liquid crystal. Thus, only the light which has the spiral direction different from that of the cholesteric liquid crystal can pass though the wide wave reflection macromolecule liquid crystal (its reflectivity is about 50% and its transmittivity is also about 50%). Therefore, the wide wave reflection macromolecule liquid crystal has polarization. The wide wave reflection macromolecule liquid crystal layer is one kind of wide wave reflection liquid crystal layer which is consisted of nematic liquid crystals having left-handed chiral ionic liquid, polymeric monomer and an initiator. The wide wave reflection macromolecule liquid crystal is obtained by the following procedures: adding a light initiator into the monomer having a photo polymerization group liquid crystal, illuminating with UV light in a range of a temperature higher than transition temperatures of the cholesteric phase and near crystalline A phase of the liquid crystal by 10 degrees so that the monomer having the photo polymerization group liquid crystal will be diffused towards one side at which a UV light source is located as the polymerization process proceeds, causing the transition temperatures of the cholesteric phase and the near crystalline A phase at a side away from the UV light source to increase up, and after that obtaining a film in which a twisted crystalline phase and a cholesteric phase are coexisted.

The wide wave reflection macromolecule liquid crystal layer can be used without the cholesteric phase, thus needing no voltage to be applied. The wide wave reflection macromolecule liquid crystal layer can keep the mirror effect of approximately 50%.

For example, the left handed light within the outside light rays which are incident onto the upper side of the wide wave reflection macromolecule liquid crystal layer is reflected, thereby achieving the mirror effect. When displaying images (in a bright state), the light rays going out of the upper polarizer will become the right-handed circularly polarized light after passing through the ¼ wavelength sheet 34, and thus the images can be displayed by means of the wide wave reflection macromolecule liquid crystal layer.

In order to increase the light efficiency, an angle between a transmission axis of the upper polarizer 14 and an optical axis of the ¼ wavelength sheet 34 is +45°.

In addition, an embodiment of the present disclosure also provides a method for producing a display apparatus having a mirror function, including the steps of:

providing a display panel 10;

providing a mirror panel 20/30; and

disposing the mirror panel at a light exiting side of the display panel, wherein the mirror panel permits a part of polarized light from the display panel 10 to transmit therethrough while reflecting a part of ambient light.

Preferably, in the above method, the step of providing the mirror panel 20 includes:

providing a first transparent substrate 21 and a second transparent substrate 22 arranged opposite to each other, and providing transparent electrode layers 23 at opposite inner side surfaces of the first and second transparent substrates 21 and 22;

applying negative liquid crystals 252 between the first and second transparent substrates 21 and 22, in which a chiral ionic liquid 251 is added. As such, a mirror panel based on the cholesteric liquid crystal layer is provided.

In one example, the method further includes the step of:

providing a power supply system having a power source 24 and a power source control part, wherein the power source is electrically connected to the two transparent electrode layers 23 respectively; and

controlling the power source by the power source control part:

(1) to output a low frequency alternating voltage, so that based on the applied low frequency alternating voltage the mirror panel is configured to permit circularly polarized light from the display panel to transmit therethrough while reflecting a part of the ambient light;

(2) to output a high frequency alternating voltage, so that based on the applied high frequency alternating voltage the cholesteric liquid crystal layer presents a pitch gradient distribution, so as to prevent the passage of the light rays from the display panel and to only reflect the ambient light;

(3) to cut off supply of electricity power to the mirror panel, so that the cholesteric liquid crystal layer maintains a transparent state so as to permit all of the polarized light from the display panel to transmit therethrough.

Preferably, in the above method, the step of providing a mirror panel 30 in another form includes:

providing a first transparent substrate 31 and a second transparent substrate 32 arranged opposite to each other;

providing a wide wave reflection macromolecule liquid crystal layer 33 between inner side surfaces of the first and second transparent substrates, wherein the wide wave reflection macromolecule liquid crystal layer has the characteristic of the cholesteric liquid crystal layer.

In addition, the method according to the present disclosure also includes the step of: providing a ¼ wavelength sheet 34 between the light exiting side of the display panel and the mirror panel.

As such, the wide wave reflection macromolecule liquid crystal layer having the characteristic of the cholesteric liquid crystal layer is provided herein and meanwhile the display apparatus having the good display effect and the mirror effect is provided herein.

Further, the step of providing the wide wave reflection macromolecule liquid crystal layer 33 includes:

adding a light initiator into the monomer having a photo polymerization group liquid crystal, illuminating with UV light in a range of a temperature higher than transition temperatures of the negative cholesteric phase and near crystalline A phase of the liquid crystal by 10 degrees, so as to obtain the wide wave reflection macromolecule liquid crystal layer. The monomer having the photo polymerization group liquid crystal will be diffused towards one side at which a UV light source is located as the polymerization process proceeds, so that the transition temperatures of the cholesteric phase and the near crystalline A phase at a side away from the UV light source will increase up, and after that a film in which a twisted crystalline phase and a cholesteric phase are coexisted, is obtained, thereby obtaining the wide wave reflection liquid crystal layer.

It should be understood that in the second embodiment of the present disclosure, the light going out of the display panel is translated into circularly polarized light after passing through the ¼ wavelength sheet, and then the mirror panel having the wide wave reflection macromolecule liquid crystal layer will permit the circularly polarized light to pass therethrough, and meanwhile reflect a part of the ambient light. Of course, based on the above disclosure of the present disclosure, the person skilled in the art will readily envisage providing the above circularly polarized light directly by the display panel, rather than by the ¼ wavelength sheet.

Obviously, as for those skilled in the art, various changes or modifications can be made to the present disclosure without departing the spirit and scope of the present disclosure. As such, if these changes or modifications of the present disclosure pertain to the scope of the pending claims of the present disclosure and equivalents thereof, then the present disclosure is intended to encompass these changes and modifications.

1. A display apparatus having a mirror function, comprising:
a display panel;
a mirror panel, provided at a light exiting side of the display panel, wherein the mirror panel is configured to permit a part of polarized light from the display panel to transmit therethrough while reflecting a part of ambient light.

2. The display apparatus according to claim 1, wherein the mirror panel comprises:
a first transparent substrate and a second transparent substrate arranged opposite to each other;
transparent electrode layers arranged respectively on opposite inner side surfaces of the first and second transparent substrates; and
a cholesteric liquid crystal layer provided between the respective transparent electrode layers of the first and second transparent substrates.

3. The display apparatus according to claim 2, wherein
the display panel is a liquid crystal display panel, and the second transparent substrate is provided on the liquid crystal display panel.

4. The display apparatus according to claim 3, further comprising:
a ¼ wavelength sheet provided between the display panel and the mirror panel.

5. The display apparatus according to claim 2, wherein
the display apparatus further comprises a power supply system comprising a power source and a power source control part, wherein the power source is electrically connected to the transparent electrode layers of the first transparent substrate and the second transparent substrate respectively.

6. The display apparatus according to claim 5, wherein
the power source control part is adapted to control the power source to output a low frequency alternating voltage, and based on the applied low frequency alternating voltage, the cholesteric liquid crystal layer permits transmission of a part of polarized light from the display panel while reflecting a part of the ambient light.

7. The display apparatus according to claim 5, wherein
the power source control part is adapted to control the power source to output a high frequency alternating voltage, and based on the applied high frequency alternating voltage, the cholesteric liquid crystal layer presents a pitch gradient distribution so as to prevent transmitting of the light from the display panel while reflecting the ambient light.

8. The display apparatus according to claim 5, wherein
the power source control part is adapted to cut off the power source, thereby keeping the cholesteric liquid crystal layer in a transparent state so as to permit the transmission of all of the polarized light from the display panel.

9. The display apparatus according to claim 1, wherein
the mirror panel comprises:
a first transparent substrate and a second transparent substrate arranged opposite to each other; and
a wide wave reflection macromolecule liquid crystal layer provided between inner side surfaces of the first and second transparent substrates,
wherein the wide wave reflection macromolecule liquid crystal layer permits the transmission of the circularly polarized light from the display panel while reflecting a part of the ambient light.

10. The display apparatus according to claim 9, wherein
the display panel is a liquid crystal display panel and comprises a polarizer located at the light exiting side thereof;
the display apparatus further comprises a ¼ wavelength sheet provided between the polarizer of the display panel and the second transparent substrate of the mirror panel, and an angle between a transmission axis of the polarizer and an optical axis of the ¼ wavelength sheet is +45.

11. The display apparatus according to claim 9, wherein
the wide wave reflection macromolecule liquid crystal layer is in a form of a film in which a twisted crystalline phase and a cholesteric phase are coexisted.

12. A method for producing a display apparatus having a mirror function, comprising the steps of:
providing a display panel;
providing a mirror panel; and
disposing the mirror panel at a light exiting side of the display panel, wherein the mirror panel permits a part of polarized light from the display panel to transmit therethrough while reflecting a part of ambient light.

13. The method according to claim 12, wherein
the step of providing the mirror panel comprises:
providing a first transparent substrate and a second transparent substrate arranged opposite to each other, and providing transparent electrode layers at opposite inner side surfaces of the first and second transparent substrates;
applying negative liquid crystals between respective transparent electrode layers of the first and second transparent substrates, a chiral ionic liquid being added into the negative liquid crystals.

14. The method according to claim 13, further comprising the step of:
providing a power supply system having a power source and a power source control part, wherein the power source is electrically connected to the two transparent electrode layers of the first and second transparent substrates respectively; and
controlling the power source by the power source control part:
(1) to output a low frequency alternating voltage, so that based on the applied low frequency alternating voltage the mirror panel is configured to permit a part of polarized light from the display panel to transmit therethrough while reflecting a part of the ambient light;
(2) to output a high frequency alternating voltage, so that based on the applied high frequency alternating voltage the cholesteric liquid crystal layer presents a pitch gradient distribution, so as to prevent the passage of the light rays from the display panel and to only reflect the ambient light;
(3) to cut off supply of electricity power to the mirror panel, so that the cholesteric liquid crystal layer maintains a transparent state so as to permit all of the polarized light from the display panel to transmit therethrough.

15. The method according to claim 12, wherein
the step of providing a mirror panel comprises:
providing a first transparent substrate and a second transparent substrate arranged opposite to each other;
providing a wide wave reflection macromolecule liquid crystal layer between inner side surfaces of the first and second transparent substrates, wherein the wide wave reflection macromolecule liquid crystal layer has a characteristic of the cholesteric liquid crystal layer.

16. The method according to claim 15, further comprising:
providing a ¼ wavelength sheet between the light existing side of the display panel and the mirror panel.

17. The method according to claim 15, wherein
the step of providing the wide wave reflection macromolecule liquid crystal layer comprises:
adding a light initiator into a monomer having a photo polymerization group liquid crystal; and
illuminating the monomer with UV light in a range of a temperature higher than transition temperatures of the negative cholesteric phase and near crystalline A phase of liquid crystal by 10 degrees, so as to obtain the wide wave reflection macromolecule liquid crystal layer.

18. The display apparatus according to claim 3, wherein
the display apparatus further comprises a power supply system comprising a power source and a power source control part, wherein the power source is electrically connected to the transparent electrode layers of the first transparent substrate and the second transparent substrate respectively.

19. The display apparatus according to claim 4, wherein
the display apparatus further comprises a power supply system comprising a power source and a power source control part, wherein the power source is electrically connected to the transparent electrode layers of the first transparent substrate and the second transparent substrate respectively.
